(19) United States
(12) Patent Application Publication
(10) Pub. No.: US 2009/0054157 A1
(43) Pub. Date: Feb. 26, 2009

(54) INTELLECTUAL PROPERTY PROTECTION FOR CONTENT CREATED WITHIN A VIRTUAL UNIVERSE

(76) Inventors: Rick A. Hamilton, II, Charlottesville, VA (US); Brian M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 11/843,975

(22) Filed: Aug. 23, 2007

(51) Int. Cl. A63F 13/00; A63F 9/24

(52) U.S. Cl. 463/43

(57) ABSTRACT

An approach that protects intellectual property rights in content created by users of a virtual universe is described. In one embodiment, there is an intellectual property rights protection tool for use in a virtual universe. A receiving component is configured to receive a request to protect intellectual property rights in content created by a user of the virtual universe. A database is configured to store content created by users of the virtual universe that have intellectual property rights therein. A search component is configured to search the database for content created by users of the virtual universe that have intellectual property rights therein that is similar to the content created by the user. An analysis component is configured to determine whether any preexisting intellectual property rights in content stored in the database precludes intellectual property protection of the content created by the user.

### FIELD OF THE INVENTION

This disclosure relates generally to virtual universes, and more specifically to facilitating the protection of intellectual property rights in content created by users of these virtual universes.

### BACKGROUND OF THE INVENTION

Virtual universes or virtual worlds are computer-based simulated environments intended for its users to inhabit and interact via avatars, which are personas or representations of the users of the virtual universes and generally take the form of two-dimensional or three-dimensional human or fantastical representations of a person's self. These types of virtual universes are now most common in massive multiplayer online games, such as Second Life which is a trademark of Linden Lab in the United States (US), other countries or both. Avatars in these types of virtual universes, which can number well over a million, have a wide range of business and social experiences.

Users through their avatars create many aspects of their virtual lives. In some virtual universes it is common that users retain the intellectual property rights in the digital content that they create in the universe. Examples of digital content that users may create include avatar characters, clothing, scripts, textures, objects and designs. Intellectual property rights in these examples of digital content may be suitable for copyright, trademark, trade dress or patent protection. Currently available virtual universes do not have the functionalities to ascertain whether intellectual property rights in previously created digital content will preclude intellectual property protection in newly created content and furthermore whether newly created digital content may infringe the intellectual property rights of other users. Therefore, methodologies that can manage the intellectual property rights in content created by users of these virtual universes are desirable.

### SUMMARY OF THE INVENTION

In one embodiment, there is a method for protecting intellectual property rights in content created by a user of a virtual universe. In this embodiment, the method comprises: receiving a request to protect intellectual property rights in content created by the user; searching for content created by users of the virtual universe that have been previously registered as having intellectual property rights therein; and determining whether any previously registered intellectual property rights in content created by users of the virtual universe precludes intellectual property protection of the content created by the user.

In a second embodiment, there is an intellectual property rights protection tool for use in a virtual universe. In this embodiment, the tool comprises a receiving component configured to receive a request to protect intellectual property rights in content created by a user of the virtual universe. A database is configured to store content created by users of the virtual universe that have intellectual property rights therein. A search component is configured to search the database for content created by users of the virtual universe that have intellectual property rights therein that is similar to the content created by the user. An analysis component is configured to determine whether any preexisting intellectual property rights in content stored in the database precludes intellectual property protection of the content created by the user.

In a third embodiment, there is a computer-readable medium storing computer instructions, which when executed, enables a computer system to protect intellectual property rights in content created by a user of a virtual universe. In this embodiment, the computer instructions comprise receiving a request to protect intellectual property rights in content created by the user; searching for content created by users of the virtual universe that have intellectual property rights therein; retrieving content created by users of the virtual universe that have intellectual property rights therein that are similar to the content created by the user; comparing the retrieved content with the content created by the user; and determining whether any preexisting intellectual property rights in content created by users of the virtual universe precludes intellectual property protection of the content created by the user.

In a fourth embodiment, there is a method for deploying an intellectual property rights protection tool for use in a computer system that protects intellectual property rights in content created by a user of a virtual universe. In this embodiment, a computer infrastructure is provided and is operable to receive a request to protect intellectual property rights in content created by the user; search for content created by users of the virtual universe that have intellectual property rights therein; and determine whether any preexisting intellectual property rights in content created by users of the virtual universe precludes intellectual property protection of the content created by the user.

### BRIEF DESCRIPTION OF THE DRAWINGS

FIG. 1 shows a high-level schematic diagram showing a networking environment for providing a virtual universe according to one embodiment of this disclosure;

FIG. 2 shows a schematic block diagram of an intellectual property rights protection tool that operates in the environment shown in FIG. 1 according to one embodiment;

FIG. 3 shows a flow chart describing the operation of the intellectual property rights protection tool shown in FIG. 2 according to one embodiment;

FIG. 4 shows an alternative embodiment in which the intellectual property rights protection tool of FIG. 2 may operate;

FIG. 5 shows a flow chart describing the operation of the intellectual property rights protection tool shown in FIG. 2 in use according to one embodiment; and

FIG. 6 shows a schematic of an exemplary computing environment in which elements of FIGS. 1, 2 and 4 may operate.

### DETAILED DESCRIPTION OF THE INVENTION

Embodiments of this disclosure are directed to a technique for protecting intellectual property rights in digital content created by users of a virtual universe. The embodiments of this disclosure protect intellectual property rights in content created by users of the virtual universe by enabling users to select content which they have created and request intellectual property protection. An intellectual property rights protection tool will receive the request and perform a search of digital content of users of the virtual universe that have previously obtained intellectual property rights protection. If there are no other intellectual property rights that have been previously registered or that are preexisting that would preclude obtaining protection, then the intellectual property rights protection tool will register the intellectual property rights associated with the selected digital content. An additional embodiment of this disclosure includes notifying users that have intellectual property rights in digital content that is similar to digital content that a user is seeking to protect similar content. Another embodiment of this disclosure includes enabling the user to obtain intellectual property rights in their digital content in other virtual universes. Still another embodiment of this disclosure includes forwarding information on the digital content to a real-world intellectual property practitioner to counsel the user on protecting the content in the real-world.

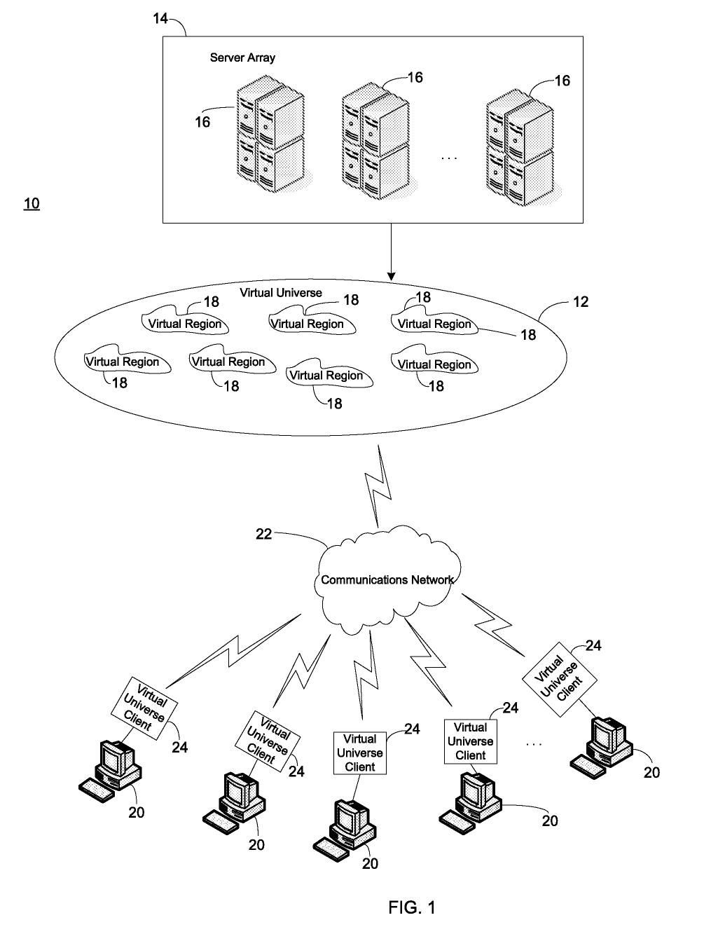

FIG. 1 shows a high-level schematic diagram showing a networking environment 10 for providing a virtual universe 12 according to one embodiment of this disclosure in which a service for protecting intellectual property rights in digital content created by users of the universe can be utilized. As shown in FIG. 1, the networking environment 10 comprises a server array or grid 14 comprising a plurality of servers 16 each responsible for managing a portion of virtual real estate within the virtual universe 12. A virtual universe provided by a typical massive multiplayer online game can employ thousands of servers to manage all of the virtual real estate. The content of the virtual real estate that is managed by each of the servers 16 within the server array 14 shows up in the virtual universe 12 as a virtual region 18.

Like the real-world, each virtual region 18 within the virtual universe 12 comprises a living landscape having things such as buildings, stores, clubs, sporting arenas, parks, beaches, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe. FIG. 1 also shows that users operating computers 20 interact with the virtual universe 12 through a communication network 22 via a virtual universe client 24 that resides in the computer. One of the ways that users of the virtual universe 12 can use the virtual universe client 24 to interact with the universe is to create content for the virtual universe. An illustrative but non-limiting listing of digital content that can be created through the virtual universe client 24 includes items such as avatar characters, clothing, scripts, textures, objects and designs.

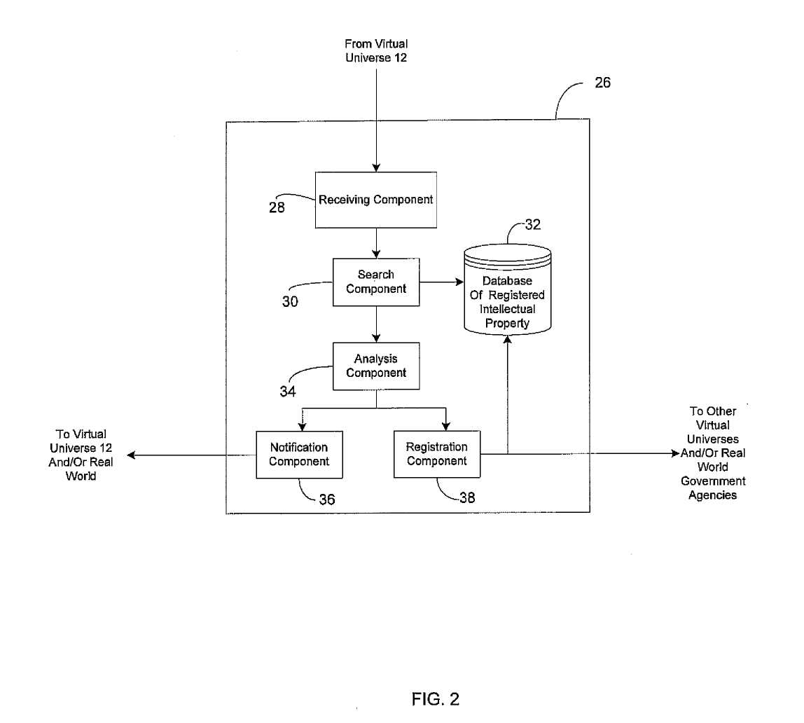

FIG. 2 shows a schematic block diagram of an intellectual property rights protection tool 26 that operates in the environment shown in FIG. 1. Although not shown in FIG. 2, the intellectual property rights protection tool 26 may reside in the server array 14 and communicate directly to the virtual universe 12 and its denizens via the virtual universe client 24. In another embodiment, the intellectual property rights protection tool 26 may reside on a separate computers remote of the server array 14 and the virtual universe client 24, but in direct communication with these systems. Still in another embodiment, parts of the intellectual property rights protection tool 26 may reside on both the server array 14 and the virtual universe client 24.

The intellectual property rights protection tool 26 facilitates the protection of intellectual property in digital content created by users of the virtual universe 12. This disclosure will not address specific types of intellectual property rights that users may have in the digital content that they create, but it is assumed that users can protect the digital content that they create through copyright, trademark, trade dress or patent protection. Furthermore, this disclosure will not address the substantive and procedural law associated with obtaining and enforcing rights in any of the above-mentioned types of intellectual property. Regardless of which type of intellectual property is suitable for protecting a user's digital content, the principles of this disclosure are equally applicable to copyright, trademark, trade dress and patent protection.

Referring back to FIG. 2, the intellectual property rights protection tool 26 comprises a receiving component 28 configured to receive a request to protect intellectual property rights in content created by a user of the virtual universe 12. In one embodiment, the user can make the request by selecting the object representative of their digital content by using mouse or a keyboard. In this embodiment, the action taken by the mouse or keyboard would be used in conjunction with a “context” menu that display actions appropriate for the selected item. As an example, the context menu could include a selection for requesting intellectual property protection for the selected object. Those skilled in the art will recognize that there are other approaches that could be used to seek intellectual property protection for digital content created by users. For example, in another embodiment, after the user has expressed a desire to protect a selected object, then the user may be prompted with graphical user interface panels requesting that he or she enter the type of intellectual property protection (e.g., copyright, trademark, trade dress or patent) that they want to obtain.

A search component 30 is configured to search for digital content created by users of the virtual universe that have been previously registered by these users. In one embodiment, the previously registered digital content is stored in a database 32. Each entry of previously registered digital content in the database may have items such an image of the object that the content embodies, a textual description of the object, three-dimensional geometric coordinates of the object, the owner of the object and the type of intellectual property rights (e.g., copyright, trademark, trade dress or patent) that the owner has in the object. Those skilled in the art will recognize that there are other data that can be stored in the database 32 and that the above listing is only illustrative of a few examples and is not limiting of these other items.

The search component 30 retrieves previously registered digital content from the database 32 that is similar to digital content that a user seeks to obtain intellectual property protection in. The search component 30 can perform the search using a variety of searching techniques. In one embodiment, the search component 30 uses a text search to search for text that describes an object in the database 32 that is similar to the text entered by a user. Using known text comparison techniques, the search component can find the closest matching previously registered items that have similar textual descriptions. In another embodiment, if the object that a user seeks to obtain intellectual property protection in is graphical in nature, then the search component 30 uses known image comparison techniques to find the closest matching previously registered items that have similar graphic images. One type of image comparison technique that can be used is a Query By Image Content (QBIC™) system developed by International Business Machines Corporation.

The amount of similar objects that the search component 30 will retrieve will depend on how unique the object is that the user seeks to protect and what form of intellectual property rights that the user seeks. In one embodiment, the search component 30 retrieves the 10 closest objects to the content that a user seeks to protect, but the number actually returned could be lower depending on the amount of similar objects found and the type of intellectual property rights in these objects. Those skilled in the art will recognize that the amount of objects retrieved in a search can vary and that number listed above is only an example and not meant to be limiting.

In another embodiment, the search component 30 is not limited to searching database 32. It is possible that previously registered objects that users have intellectual property rights in may be stored elsewhere in the virtual universe. For example, these objects may be stored in a database that resides in a server in the server array 14 that contains an inventory listing properties and possessions that each avatar owns such as houses, cars, sporting equipment, appearance, attire, created content, etc. In this embodiment, the search component 30 would search through all of the possessions of each avatar in the universe to see if there were any objects that are similar to the object desired to be protected by a user. To speed up this type of search it may be desirable to tag items in these inventories as intellectual property items or to have an inventory subset that contains intellectual property items.

For all embodiments, the search component 30 may be restricted according to location. For example, a user may be interested in intellectual property rights only within a certain radius of his location, within a certain region of the virtual world such as a virtual region or island, or within inventories of people who frequently visit a particular region of the virtual world. Thus, the search component may not need to search the entire virtual universe for possible matches.

In another embodiment, the search component 30 can search outside the virtual universe 12 and into other virtual universes as well as other databases that may exist in the real-world. For example, the search component 30 can search in other virtual universes that have databases or repositories storing digital content that users have noted as being protected by one or more forms of intellectual property rights. It is also possible that the search component could search databases that exist in the real world such as databases that exists for patents, trademarks and copyrights.

An analysis component 34 receives the results retrieved from the search component 30 and is configured to determine whether any previously registered intellectual property rights in content stored in the database 32 precludes intellectual property protection of the content created by the user. The analysis component 34 can determine whether any previously registered intellectual property rights precludes intellectual property protection by analyzing the results of the search component 30. For example, if the search component 30 has discovered that content created by the user is very close to previously registered items in terms of text or graphical attributes, then the previously registered intellectual property is likely to preclude intellectual property protection of the content created by the user. Naturally, such matches will sometimes be imperfect. For example, a logo or item design may be deemed to be close within a particular threshold of confidence or closeness. The closer the match, the more likely that the intellectual property overlaps.

In addition to determining whether a user can obtain intellectual property rights in a particular object, the analysis component 34 is further configured to ascertain what form of intellectual property rights (e.g., copyright, trademark, trade dress or patent) are suitable for the digital content created by the user in response to a determination that none of the previously registered intellectual property rights precludes intellectual property protection. In this embodiment, the analysis component 34 can be programmed to look at the image and/or textual description associated with the object and determine how it is used within the virtual universe 12. For example, if the object created is a vehicle, then the analysis component 34 using artificial intelligence data processing techniques might suggest design patent protection or a copyright on the design. Perhaps this vehicle may have a different style steering wheel then what is currently offered or used in the virtual universe. In this case, the analysis component 34 might recommend trade dress protection if this steering wheel shape will be used in all vehicles created by the user and perhaps offered to sale to other avatars in the virtual universe, such that the shape of this steering wheel would be indicative of the source of the steering wheel.

Referring back to FIG. 2, the intellectual property rights protection tool 26 further comprises a notification component 36 that is configured to notify the user of the search results and the analysis from the analysis component 34. If the requester still wishes to register their selected object, then he or she will confirm this selection with the intellectual property rights protection tool 26. Alternatively, if the user believes that preexisting intellectual property rights in digital contact precludes them from obtaining intellectual property protection, then the user may opt to cancel or abandon the registration process.

The notification component 36 is further configured to notify users of the virtual universe 12 that have intellectual property rights in digital content that is similar to the digital content created by a user, that the user has an intent to obtain intellectual property protection in this content. The notification provided by the notification component 36 can be provided in one of many forms. For example, the notification can be provided by an instant message, email, or audio message. The users can then decide whether they want to oppose the registration of any intellectual property rights sought by the user. The manner of opposition may comprise having the user with an interest in opposing registration contact the user seeking registration and try to resolve the dispute amicably. In another embodiment, there could be an arbiter associated with or without the virtual universe that makes the final decision on whether to permit the user to seek intellectual property protection. Those skilled in the art will recognize that these examples are only illustrative of a few examples of conducting an opposition and that there are a number of different approaches that can be used to resolve a dispute.

In another embodiment, the notification component 36 is configured to forward information on the digital content created by the user to a real-world intellectual property law practitioner for counseling on protecting the intellectual property rights in the contact in the real-world. For example, the notification component 36 may search through a database of intellectual property practitioners and find people that may be in the same geographic location as the user and provide contact information of these practitioners. In another embodiment, the notification component 36 may recommend a listing of practitioners that specialize in one area of intellectual property law that is relevant to the digital content that a user seeks to protect.

FIG. 2 shows that the intellectual property rights protection tool 26 further comprises a registration component 38 configured to register the intellectual property rights in the content created by the user in the database 32 in response to a determination that none of the previously registered intellectual property rights in content created by users of the virtual universe precludes intellectual property protection. In one embodiment, it is possible that the user may seek to override the decision made by the analysis component 34 and still seek protection.

In another embodiment, the registration component 38 is configured to seek intellectual property protection rights in the content in other virtual universes outside virtual universe 12. In this embodiment, the registration component 38 provides information on the content that the user seeks to protect to other virtual universes outside the virtual universe 12, which will then determine if there are preexisting rights in intellectual property that are similar to the content that the user seeks to protect. Assuming that these virtual universes have capabilities as described above to search and determine whether there are preexisting intellectual property rights that may preclude protection, the user will then be notified as to the likelihood of obtaining protection in these universes.

The registration component 38 is also configured to forward information on the content created by the user to a real-world government agency for protection of their content. In this embodiment, the registration would take information associated with the content and prepare documents for filing in a particular government agency. For example, the registration component 38 could take the information associated with a newly created vase and automatically fill out a copyright registration form that is filed in a government copyright office. In this embodiment, since the user would be filing pro se, and not with the assistance of an intellectual property practitioner, then the notification component 36 would not have to contact a practitioner for assistance.

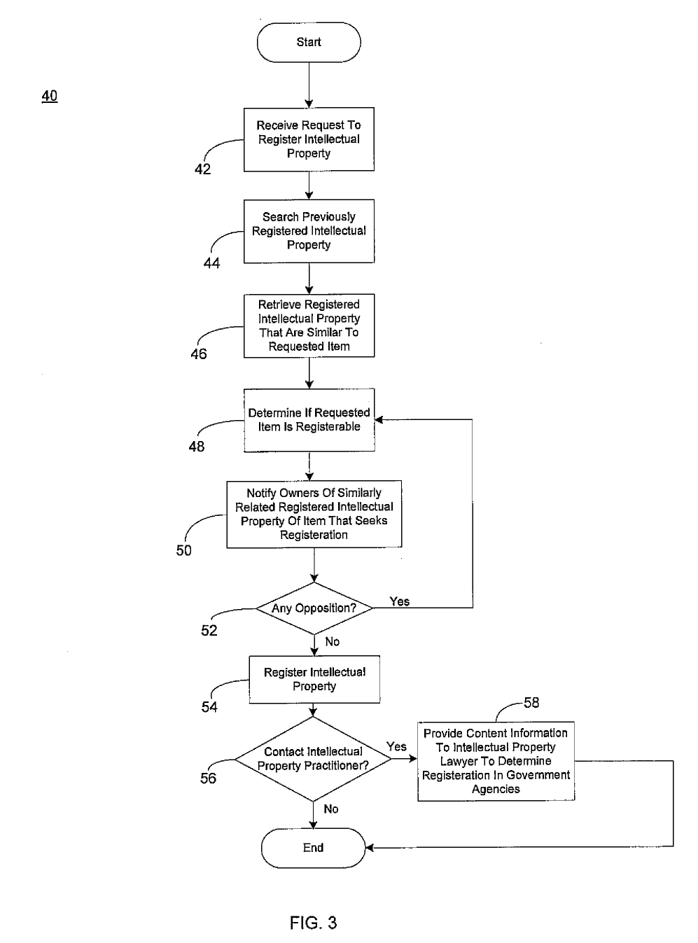

FIG. 3 shows a flow chart 40 describing the operation of the intellectual property rights protection tool 26 shown in FIG. 2. The operation begins with the user selecting an object in the virtual universe that he or she created and would like to obtain intellectual property protection therefor. At 42 the receiving component 28 receives the user request to protect the specific digital content (i.e., object) that he or she created. The search component 30 then searches the database 32 at 44 for digital content created by users of the virtual universe that have been previously registered by these users. As mentioned before, the search component 30 uses known text and image search methodologies to find previously registered items that are similar to the object that the user is interested in protecting.

The search component 30 then retrieves previously registered content from the database 32 at 46 that are similar to the user's digital content. The search component 30 retrieves the most closely related items from database 32. As mentioned before, the number of entries retrieved can vary and will depend on number of factors such as the number of items that are similar and the type of intellectual property rights in these objects. The analysis component 34 receives the results retrieved from the search component 30 and determines at 48 whether any previously registered intellectual property rights in content stored in the database 32 precludes intellectual property protection of the content selected by the user.

The notification component 36 notifies the user of the search results and the analysis from the analysis component 34 at 50. In one embodiment, the notification component 36 will also notify users of the virtual universe 12 that have intellectual property rights in content that is similar to the content created by a user, that the user has an intent to obtain intellectual property protection in their content. The users can then decide whether they want to oppose the registration of any intellectual property rights sought by the user. If there is opposition as determined at 52, then the parties can try to resolve the opposition by reevaluating the object in steps 48-50. Although not shown in FIG. 3, if the parties are unable to resolve the dispute, then the process will stop or be suspended until the parties can resolve the dispute.

If it is determined at 52 that there is no opposition to the type of intellectual property protection sought by the user for the object, then the process continues at 54 where the registration component 38 will register the object and form of intellectual property rights protection in the object in database 32. The user is also given the opportunity to contact an intellectual property practitioner at 56. If the user is interested in contacting the intellectual property practitioner, then the notification component 36 will forward information on the content created by the user to a real-world intellectual property law practitioner for counseling on protecting the intellectual property rights in the content in the real-world at 58. Alternatively, if there is no interest then process 40 is completed.

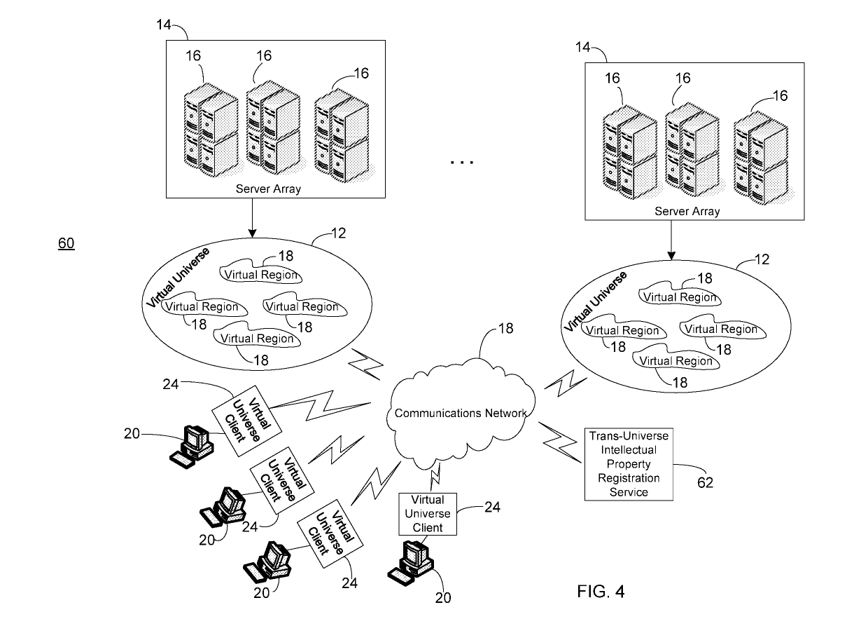

FIG. 4 shows an alternative embodiment in which the intellectual property rights protection tool 26 shown in FIG. 2 may operate in a trans-virtual universe 60. In this embodiment, the intellectual property rights protection tool 26 is incorporated in a trans-universe intellectual property registration service 62. As shown in FIG. 4, the trans-universe intellectual property registration service 62 is accessible to more than one virtual universe 12 through the virtual universe clients 24 that interact with these universes, via communications network 18. In this embodiment, the trans-universe intellectual property registration service 62 serves as a centralized location for users from within a multiple of virtual universes, for registering, tracking and arbitrating users' claims for certain intellectual property rights in content created by users of these universes. Because the trans-universe intellectual property registration service 62 incorporates the intellectual property rights protection tool 26, the service can perform the above-noted functions in the manner described earlier. As a result, the trans-universe intellectual property registration service 62 could offer intellectual property protection for all of the virtual universes or only protection in a limited set of universes (e.g., an object could have intellectual protection in virtual universes A-C but not virtual universes D-J).

In one embodiment, the trans-universe intellectual property registration service 62 could charge fees for storing and registering intellectual property rights in certain content created by the users of these virtual universes. In this embodiment, payment can be handled in an automatic and streamlined manner and can consist of real-world money, virtual money, a blend of different world money depending on the nature of the intellectual property or trans-universe barter. In another embodiment, the trans-universe intellectual property registration service 62 could be offered as a service to users and/or the virtual universes on a subscription and/or fee basis.

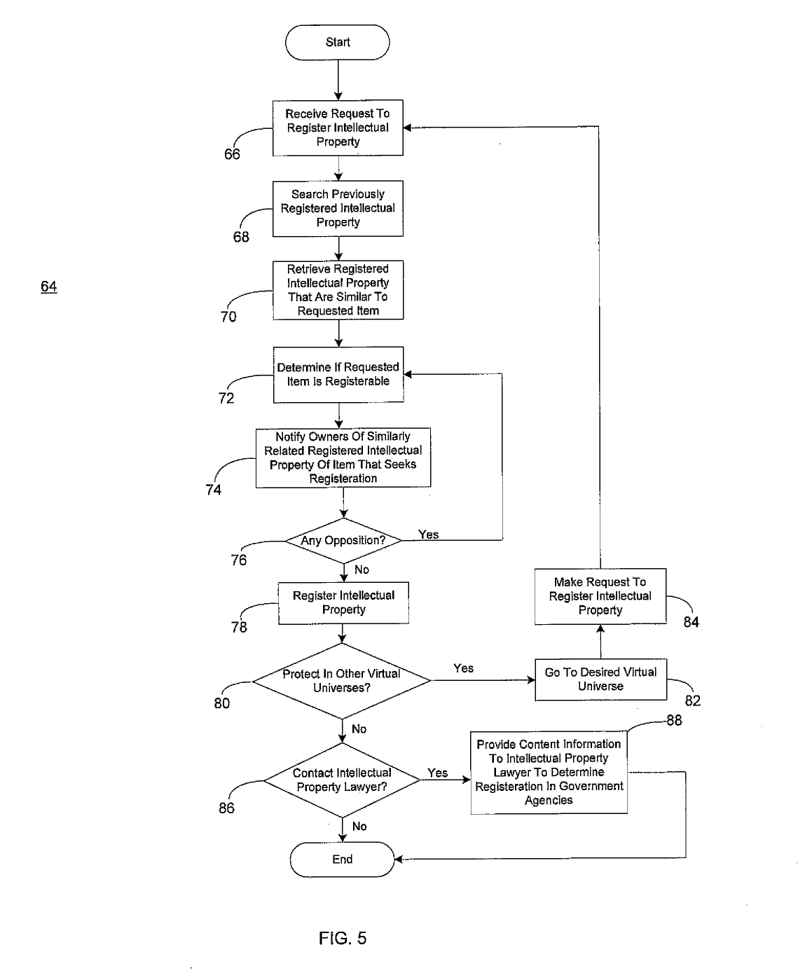

FIG. 5 shows a flow chart 64 describing the operation of the intellectual property rights protection tool shown in use in the trans-universe intellectual property registration service 62. Because process acts 66-78 of FIG. 5 are similar to process acts 42-54 of FIG. 2, a separate discussion is not provided.

Referring now to FIG. 5, after the digital content has been registered at process block 78, the intellectual property rights protection tool determines at 80 whether the user wants to protect the content in another universe. If the user does want to protect the content in another virtual universe then the user will in one embodiment go to the desired virtual universe at 82 and make a request to register the intellectual property in that universe at 84. In this embodiment, after the user has made his or her request then process acts 66-80 will repeat until it is determined that the user does not desire to obtain protection in other virtual universes. At this point, process blocks 86-88 which are similar to acts 56-58 described in FIG. 2 are acted on. In particular, if the user does not want to engage an intellectual property practitioner then the process will end.

The foregoing flow charts of FIGS. 2 and 5 show some of the processing functions associated with using the intellectual property rights protection tool 26 to protect content created by users within a virtual universe. In this regard, each block in the tool represents a component and a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe these processing acts may be added. For example, in FIG. 5, it is possible to have a user file for a trans-universe registration and not go to each individual virtual universe to seek intellectual property protection. In this embodiment, limited universe protection can be granted for certain virtual universes or it is possible to obtain protection in all universes.

In another embodiment of this disclosure, the intellectual property rights protection tool 26 could be offered to the provider of a virtual universe or a third party service provider could offer this tool as a service by performing the functionalities described herein on a subscription and/or fee basis. In this case, the provider of the virtual universe or the third party service provider can create, deploy, maintain, support, etc., the intellectual property rights protection tool 26 that performs the processes described in the disclosure. In return, the virtual universe or the third party service provider can receive payment from the virtual universe residents via a universe economy management component and/or a commercial transaction management component.

In still another embodiment, the methodologies disclosed herein can be used within a computer system to facilitate intellectual property protection of content created by users of a virtual universe. In this case, the intellectual property rights protection tool 26 can be provided and one or more systems for performing the processes described in the disclosure can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the disclosure.

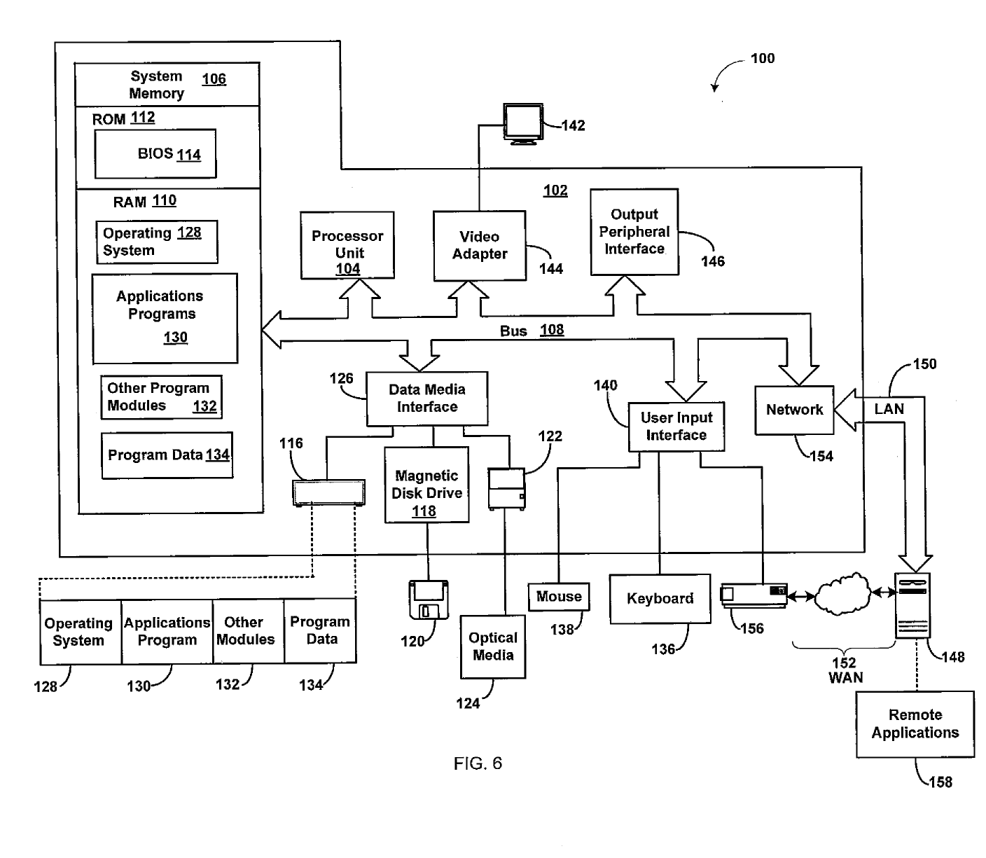

FIG. 6 shows a schematic of an exemplary computing environment 100 in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 6.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers (PC), server computers, thin clients, thick clients, handheld or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 6, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 6, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 6 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130, other program modules 132, and program data 134 or some combination thereof, may include an implementation of the networking environment 10 of FIG. 1 including the server array 14, the virtual universe client 24, the intellectual property rights protection tool 26 and the trans-universe intellectual property registration service 62.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 6 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 6 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable media containing computer instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this disclosure an approach for intellectual property protection for content created within a virtual universe. While the disclosure has been particularly shown and described in conjunction with a preferred embodiment thereof, it will be appreciated that variations and modifications will occur to those skilled in the art. Therefore, it is to be understood that the appended claims are intended to cover all such modifications and changes as fall within the true spirit of the invention.

What is claimed is:

1. A method for protecting intellectual property rights in content created by a user of a virtual universe, comprising:
receiving a request to protect intellectual property rights in content created by the user;
searching for content created by users of the virtual universe that have been previously registered as having intellectual property rights therein; and
determining whether any previously registered intellectual property rights in content created by users of the virtual universe precludes intellectual property protection of the content created by the user.

2. The method according to claim 1, further comprising retrieving content created by users of the virtual universe that have been previously registered as having intellectual property rights therein that are similar to the content created by the user.

3. The method according to claim 2, further comprising comparing the retrieved content with the content created by the user.

4. The method according to claim 1, further comprising ascertaining what form of intellectual property rights are suitable for the content created by the user in response to a determination that none of the previously registered intellectual property rights in content created by users of the virtual universe precludes intellectual property protection.

5. The method according to claim 1, further comprising registering the intellectual property rights in the content created by the user in response to a determination that none of the previously registered intellectual property rights in content created by users of the virtual universe precludes intellectual property protection.

6. The method according to claim 1, further comprising notifying users of the virtual universe that have intellectual property rights in content that is similar to the content created by the user, that the user has an intent to obtain intellectual property protection in the created content

7. The method according to claim 1, further comprising enabling the user to seek intellectual property protection rights in the content in other virtual universes.

8. The method according to claim 1, further comprising forwarding information on the content created by the user to a real-world intellectual property law practitioner for counseling on protecting the intellectual property rights in the content in the real-world.

9. An intellectual property rights protection tool for use in a virtual universe, comprising:
a receiving component configured to receive a request to protect intellectual property rights in content created by a user of the virtual universe;
a database configured to store content created by users of the virtual universe that have intellectual property rights therein;
a search component configured to search the database for content created by users of the virtual universe that have intellectual property rights therein that is similar to the content created by the user; and
an analysis component configured to determine whether any preexisting intellectual property rights in content stored in the database precludes intellectual property protection of the content created by the user.

10. The intellectual property rights protection tool according to claim 9, wherein the search component is further configured to compare the retrieved content with the content created by the user.

11. The intellectual property rights protection tool according to claim 9, wherein the analysis component is further configured to ascertain what form of intellectual property rights are suitable for the content created by the user in response to a determination that none of the preexisting intellectual property rights in content created by users of the virtual universe precludes intellectual property protection.

12. The intellectual property rights protection tool according to claim 9, further comprising a registration component configured to register the intellectual property rights in the content created by the user in the database in response to a determination that none of the preexisting intellectual property rights in content created by users of the virtual universe precludes intellectual property protection.

13. The intellectual property rights protection tool according to claim 9, further comprising a registration component configured to seek intellectual property protection rights in the content in other virtual universes.

14. The intellectual property rights protection tool according to claim 9, further comprising a notification component configured to notify users of the virtual universe that have intellectual property rights in content that is similar to the content created by the user, that the user has an intent to obtain intellectual property protection in the created content.

15. The intellectual property rights protection tool according to claim 9, further comprising a notification component configured to forward information on the content created by the user to a real-world intellectual property law practitioner for counseling on protecting the intellectual property rights in the content in the real-world.

16. A computer-readable medium storing computer instructions, which when executed, enables a computer system to protect intellectual property rights in content created by a user of a virtual universe, the computer instructions comprising:
receiving a request to protect intellectual property rights in content created by the user;
searching for content created by users of the virtual universe that have intellectual property rights therein;
retrieving content created by users of the virtual universe that have intellectual property rights therein that are similar to the content created by the user;
comparing the retrieved content with the content created by the user; and
determining whether any preexisting intellectual property rights in content created by users of the virtual universe precludes intellectual property protection of the content created by the user.

17. The computer-readable medium according to claim 16, further comprising instructions for ascertaining what form of intellectual property rights are suitable for the content created by the user in response to a determination that none of the preexisting intellectual property rights in content created by users of the virtual universe precludes intellectual property protection.

18. The computer-readable medium according to claim 16, further comprising instructions for registering the intellectual property rights in the content created by the user in response to a determination that none of the preexisting intellectual property rights in content created by users of the virtual universe precludes intellectual property protection.

19. The computer-readable medium according to claim 18, further comprising instructions for charging a fee for registering the intellectual property rights.

20. The computer-readable medium according to claim 16, further comprising instructions for notifying users of the virtual universe that have intellectual property rights in content that is similar to the content created by the user, that the user has an intent to obtain intellectual property protection in the created content

21. The computer-readable medium according to claim 16, further comprising instructions for enabling the user to seek intellectual property protection rights in the content in other virtual universes.

22. The computer-readable medium according to claim 16, further comprising instructions for forwarding information on the content created by the user to a real-world intellectual property law practitioner for counseling on protecting the intellectual property rights in the content in the real-world.

23. A method for deploying an intellectual property rights protection tool for use in a computer system that protects intellectual property rights in content created by a user of a virtual universe, comprising:
providing a computer infrastructure operable to:
receive a request to protect intellectual property rights in content created by the user;
search for content created by users of the virtual universe that have intellectual property rights therein; and
determine whether any preexisting intellectual property rights in content created by users of the virtual universe precludes intellectual property protection of the content created by the user.
